(19) United States
(12) Patent Application Publication
(10) Pub. No.: US 2014/0301767 A1
(43) Pub. Date: Oct. 9, 2014

(54) Mechanical Interface for an Auxiliary Power Source

(71) Applicant: Aura Systems, Inc., El Segundo, CA (US)

(72) Inventor: Yedidia Cohen, Beverly Hills, CA (US)

(21) Appl. No.: 13/859,644

(22) Filed: Apr. 9, 2013

(51) Int. Cl. F16B 1/00

(52) U.S. Cl. CPC F16B 1/0071; F16B 2001/0092
USPC 403/13

(57) ABSTRACT

A mechanical interface including at least one surface, a cutout on the at least one surface; and a plurality of mounting holes on the at least one surface, wherein the plurality of mounting holes are each situated on a circumferential arc bordering the cutout and centered on a center point of the cutout, and wherein each of the plurality of mounting holes is equidistant from each of the next two mounting holes on either side along the circumferential arc, and wherein each of the plurality of mounting holes is located a radial distance from the center point. In one example, the mechanical interface is for mounting an auxiliary power source adjacent to a vehicle engine. In one example, the cutout is optional.

### FIELD

This disclosure relates generally to a mechanical interface. More particularly, the disclosure relates to a mechanical interface for an auxiliary power source.

### BACKGROUND

All vehicles include a vehicle engine for supplying power. The power supplied by the vehicle engine is used for mobilizing the vehicle and supplying power to some electrical devices within the vehicle. For example, the vehicle may include electrical devices, such as but not limited to, an air conditioning and/or heating system, an audio system (e.g., radio, compact disc (CD) player), a video system, a navigation system, a communication system (e.g., wireless phone system), and/or one or more electrical plugs, etc.

Many of the power requirements of the electrical devices are supplied by the vehicle engine, particularly for non-commercial vehicles. However, some non-commercial vehicles and many commercial vehicles include electrical payloads with power requirements that far exceed the output of the vehicle engine alone, especially when the main use of the vehicle engine is for mobilizing the vehicle. One such example of an electrical payload that requires a large amount of power is a refrigeration unit. Thus, an auxiliary power source may be added to supplement the power requirements of a vehicle and its electrical devices. With the addition of an auxiliary power source, a mechanical interface may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Disclosed is a mechanical interface. According to one aspect, a mechanical interface, including at least one surface; a cutout on one of the at least one surface; a plurality of mounting holes on one of the at least one surface, wherein the plurality of mounting holes are each situated on a circumferential arc bordering the cutout and each of the plurality of mounting holes is equidistant from each of the next two mounting holes on either side along the circumferential arc; at least two standoffs on one of the at least one surface for allowing alignment with a vehicle engine; and at least one mounting post on one of the at least one surface for supporting one of the following: a pulley, a belt, a cable, a tensioner, a fluid tank, an alternator or an AC system.

According to another aspect, a mechanical interface, including at least two surfaces; a cutout on one of the at least two surfaces; and a plurality of mounting holes on one of the at least two surfaces, wherein the plurality of mounting holes are each situated on a circumferential arc bordering the cutout and centered on a center point of the cutout, and wherein each of the plurality of mounting holes is equidistant from each of the next two mounting holes on either side along the circumferential arc, and wherein each of the plurality of mounting holes is located a radial distance from the center point.

According to one aspect, a mechanical interface, including at least one surface; a circumferential arc on one of the at least one surface, wherein the circumferential arc includes a center point; a plurality of mounting holes on one of the at least one surface, wherein the plurality of mounting holes are each situated on the circumferential arc and each of the plurality of mounting holes is equidistant from each of the next two mounting holes on either side along the circumferential arc; at least two standoffs on one of the at least one surface for allowing alignment with a vehicle engine; and at least one mounting post on one of the at least one surface for supporting one of the following: a pulley, a belt, a cable, a tensioner, a fluid tank, an alternator or an AC system.

Advantages of the present disclosure may include the ability to mount an auxiliary power source in a tight space, particularly in a vehicle setting where efficiency of space usage is desirable.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of a mechanical interface for mounting an auxiliary power source in a vehicle engine compartment.

FIG. 2 illustrates an example side view of a mechanical interface.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

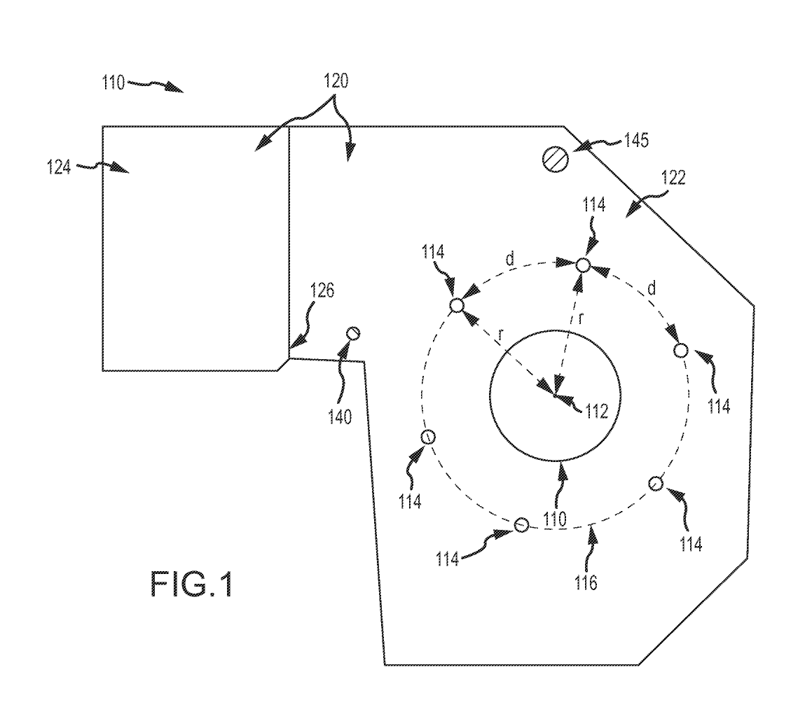

FIG. 1 illustrates an example of a mechanical interface 100 for mounting an auxiliary power source 150 (not shown) in a vehicle engine compartment 190 (not shown). In one example, the mechanical interface is for securing (e.g., mounting) the auxiliary power source 150 adjacent to a vehicle engine. Although FIG. 1 shows the mechanical interface 100 in a generally L shape configuration, one skilled in the art would understand that other shapes, for example, a generally square shape, a generally rectangular shape, a generally U shape, and other shapes are within the scope and spirit of the present disclosure. And, the present disclosure is not limited to the generally L shape configuration which is illustrated herein as a mere example.

In one example, the vehicle engine compartment 190 is the compartment beneath the front hood of the vehicle where the vehicle engine is housed. In another example, the vehicle engine compartment 190 is in the back portion of a vehicle. Although in some examples, the auxiliary power source 150 and the vehicle engine are housed in the same compartment, it is not always necessary that they are housed in the same compartment. Examples of auxiliary power source 150 may include an alternating current (AC) generator, a direct current (DC) generator or a hydraulic pump. One skilled in the art would understand that the examples of auxiliary power source 150 listed herein are not exclusive and that other types of auxiliary power sources may be used within the scope and spirit of the present disclosure. In one example, the auxiliary power source is coupled to the vehicle engine for providing additional power. The coupling may be to the vehicle engine itself or to an alternator or a generator associated with the vehicle engine.

In one example, the mechanical interface 100 includes a cutout 110. In one example, the cutout 110 is circular in shape with a center point 112. One skilled in the art would understand that the center point 112 is not a physical point on the mechanical interface 100; rather, the center point 112 is a location of the center of the cutout 110. The cutout 110, in one example, allows portions of the auxiliary power source 150 to protrude through the cutout 110 so as to allow other portions of the auxiliary power source 150 to touch or be aligned with one or more surfaces 120 of the mechanical interface 100. Allowing the auxiliary power source 150 to protrude through the cutout 110 may allow improved ventilation or cooling of the auxiliary power source 150.

The mechanical interface 100 may include a plurality of mounting holes 114. In one example, the mounting holes 114 are equally spaced from each other. For example, when measured along a circumferential arc 116 which borders the cutout 110 and is centered on the center point 112, each mounting hole 114 is equidistant (e.g., distance “d” as shown in FIG. 1) from each of the next two mounting holes on either side along the circumferential arc.

In one example, the locations of each of the mounting holes 114 extend radially outward from the center point 112 and are equidistant (e.g., distance “r” as shown in FIG. 1) as measured radially from the center point 112. Some example quantities of the plurality of mounting holes 114 include 4, 6, 8, 10 and/or 12 mounting holes. In one example, the mounting holes 114 are used for securing (e.g., mounting) the auxiliary power source 150 to the mechanical interface 100, for example, through the use of screws, bolts, clasps, etc. One skilled in the art would understand that other devices (not mentioned herein) for securing the auxiliary power source 150 to the mechanical interface 100 through the mounting holes 114 may be used within the scope and spirit of the present disclosure.

In one example, the mechanical interface 100 includes at least one standoff 140. Placement of the standoff 140 may be used to achieve better alignment of the surfaces 120 of the mechanical interface 100 to components within the vehicle engine compartment 190, for example, with the vehicle engine. The standoffs 140 may be located on either side of the surfaces 120 of mechanical interface 100. The locations of the standoffs 140 may vary according to the contours of the auxiliary power source, vehicle engine and/or components to be aligned adjacent to the mechanical interface 100. In one example, one or more standoffs 140 are used to align the surfaces 120 of the mechanical interface 100 with pulleys and/or belts associated with the vehicle engine. One skilled in the art would understand that one or more standoffs 140 may be included on the mechanical interface 100 to achieve better alignment to any component associated with the placement of the mechanical interface, and the component is not limited to the vehicle engine, pulleys and/or belts.

In one example, the mechanical interface 100 includes at least one mounting post 145 which may be used for mounting, for example, tensioners, idler pulleys, alternators, fluid tanks, air conditioning (AC) systems, etc. associated with a vehicle. In one example, the mounting post 145 is used to support cables within the vehicle engine compartment 190. The locations of the mounting post 145 may vary according to the need of the component(s) needing mounting or support.

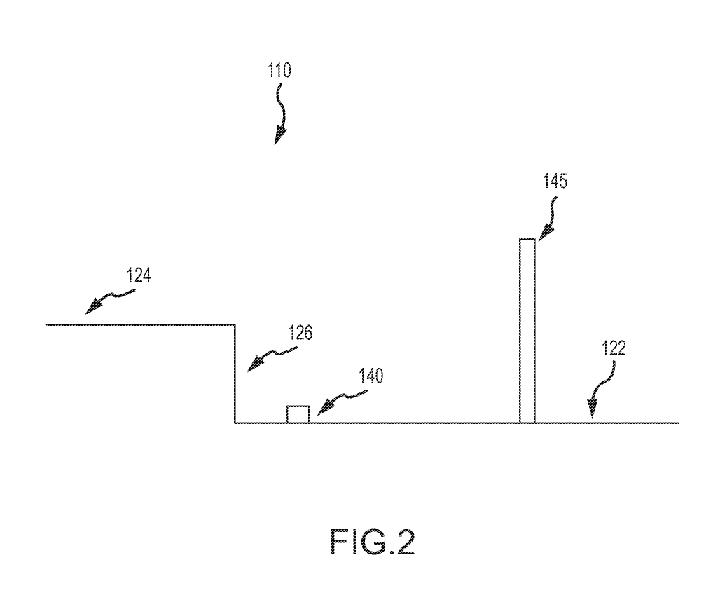

FIG. 2 illustrates an example side view of a mechanical interface. In one aspect, the mechanical interface 100 includes two surfaces wherein a second surface 124 is elevated from a first surface 122 as shown in FIG. 2. In one example, the elevation of the second surface 124 is achieved by an elevation plate 126. In one example, the amount of elevation of the second surface 124 relative to the first surface 122 is determined by the contour of the nearby component(s), for example, the vehicle engine which may be mounted adjacent to the mechanical interface 100. In one example, the respective dimensions of the first surface 122 and the second surface 124 are determined by the contour of the vehicle engine or the contour of the nearby component(s). The two surfaces 122, 124 are included to achieve better alignment of the mechanical interface 100 to components within the vehicle engine compartment 190, for example, with the vehicle engine. In one example, multiple surfaces of varied dimensions and relative elevations from each other are included in the mechanical interface 100 to achieve alignment. In one example, each of the multiple surfaces is aligned to a housing portion of a vehicle engine.

In one example, the plurality of mounting holes 114 and the cutout 110 are located on the first surface 122 as shown in FIG. 1. However, one skilled in the art would understand that the plurality of mounting holes 114 and the cutout 110 may also be located on the second surface and be within the scope and spirit of the present disclosure. In one example, the determination of the locations of the plurality of mounting holes 114 and the cutout 110 may depend on the contours of the auxiliary power source 150 and/or the vehicle engine.

In one example, the mechanical interface 100 is for mounting a pancake generator or a pancake motor. For example, the cutout 110 allows portions of the pancake generator or pancake motor to protrude through the mechanical interface 100 to achieve a better fitting and/or to allow better ventilation and heat dissipation of the pancake generator or the pancake motor. In one aspect, the pancake generator or the pancake motor has an axial length shorter than a radial length.

In one aspect, the mechanical interface, includes at least one surface and a circumferential arc on one of the at least one surface. In one example, the circumferential arc includes a center point on the surface with a plurality of mounting holes situated on the circumferential arc. In one example, each of the plurality of mounting holes is equidistant from each of the next two mounting holes on either side along the circumferential arc. In one example, the mechanical interface includes at least two standoffs on one of the at least one surface for allowing alignment with a vehicle engine; and at least one mounting post on one of the at least one surface for supporting one of the following: a pulley, a belt, a cable, a tensioner, a fluid tank, an alternator or an AC system. In one example, the mechanical interface does not include a cutout.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A mechanical interface, comprising:
at least one surface;
a cutout on one of the at least one surface;
a plurality of mounting holes on one of the at least one surface, wherein the plurality of mounting holes are each situated on a circumferential arc bordering the cutout and each of the plurality of mounting holes is equidistant from each of the next two mounting holes on either side along the circumferential arc;
at least two standoffs on one of the at least one surface for allowing alignment with a vehicle engine; and
at least one mounting post on one of the at least one surface for supporting one of the following: a pulley, a belt, a cable, a tensioner, a fluid tank, an alternator or an AC system.

2. The mechanical interface of claim 1, wherein the circumferential arc is centered on a center point of the cutout.

3. The mechanical interface of claim 2, wherein each of the plurality of mounting holes is located a radial distance from the center point.

4. The mechanical interface of claim 3, wherein the plurality of mounting holes is six mounting holes.

5. The mechanical interface of claim 1, wherein the at least one surface comprises a first surface and a second surface, wherein the second surface is elevated from the first surface.

6. The mechanical interface of claim 2, wherein the plurality of mounting holes are used for securing an auxiliary power source to the mechanical interface.

7. The mechanical interface of claim 6, wherein the auxiliary power source is one of either a pancake generator or a pancake motor.

8. The mechanical interface of claim 7, wherein at least one of a screw, a bolt or a clasp is used on one of the plurality of mounting holes to secure the auxiliary power source to the mechanical interface.

9. The mechanical interface of claim 8, wherein a portion of the auxiliary power source protrudes through the cutout.

10. The mechanical interface of claim 9, wherein the auxiliary power source is coupled to a vehicle engine for providing additional power.

11. A mechanical interface, comprising:
at least two surfaces;
a cutout on one of the at least two surfaces; and
a plurality of mounting holes on one of the at least two surfaces, wherein the plurality of mounting holes are each situated on a circumferential arc bordering the cutout and centered on a center point of the cutout, and wherein each of the plurality of mounting holes is equidistant from each of the next two mounting holes on either side along the circumferential arc, and wherein each of the plurality of mounting holes is located a radial distance from the center point.

12. The mechanical interface of claim 11, wherein a first of the at least two surfaces is elevated from a second of the at least two surfaces.

13. The mechanical interface of claim 11, wherein the cutout is circular in shape.

14. The mechanical interface of claim 13, wherein an auxiliary power source is secured on the mechanical interface through the plurality of mounting holes.

15. The mechanical interface of claim 14, wherein the plurality of mounting holes is located on the second of the at least two surfaces.

16. The mechanical interface of claim 14, wherein the auxiliary power source is a pancake generator.

17. The mechanical interface of claim 16, wherein each of the at least two surfaces is aligned to a housing portion of a vehicle engine.

18. The mechanical interface of claim 17, further comprising a standoff on one of the at least two surfaces.

19. The mechanical interface of claim 17, further comprising a mounting post on one of the at least two surfaces.

20. The mechanical interface of claim 19, wherein the mounting post supports one of the following: a pulley, a belt, a cable, a tensioner, a fluid tank, an alternator or an AC system.

21. A mechanical interface, comprising:
at least one surface;
a circumferential arc on one of the at least one surface, wherein the circumferential arc includes a center point;
a plurality of mounting holes on one of the at least one surface, wherein the plurality of mounting holes are each situated on the circumferential arc and each of the plurality of mounting holes is equidistant from each of the next two mounting holes on either side along the circumferential arc;
at least two standoffs on one of the at least one surface for allowing alignment with a vehicle engine; and
at least one mounting post on one of the at least one surface for supporting one of the following: a pulley, a belt, a cable, a tensioner, a fluid tank, an alternator or an AC system.
